(19) United States
(12) Patent Application Publication
(10) Pub. No.: US 2012/0114139 A1
(43) Pub. Date: May 10, 2012

(54) METHODS AND SYSTEMS FOR SUPPRESSING NOISE

(75) Inventors: Shih-Yu PAN, Tainan City (TW); Chih-Yuan Yu, Kaohsiung City (TW); Jiun-Bin Huang, Taichung City (TW); Min-Qiao Lu, Tainan City (TW)

(73) Assignee: INDUSTRIAL TECHNOLOGY RESEARCH INSTITUTE, Hsin-Chu (TW)

(21) Appl. No.: 13/082,917

(22) Filed: Apr. 8, 2011

(30) Foreign Application Priority Data
Nov. 5, 2010 (TW) 099138142

(51) Int. Cl. H04B 15/00

(52) U.S. Cl. 381/94.1

(57) ABSTRACT

The present invention relates to a suppressing noise system applied in a mobile device, comprises: at least two microphones are used for respectively transmitting a first audio signal with noise and a second audio signal with noise; a pre-processing unit is coupled to the at least two microphones for oversampling the first and second audio signals, downsampling the sampled first and second audio signals, and then generating a first adjusted signal and a second adjusted signal; and a suppressing noise device is coupled to the pre-processing device for filtering noise in the first and second adjusted signals once again, and outputting a third audio signal.

### TECHNICAL FIELD

The present invention relates to a method and system for suppressing noise, and more particularly, to a method and system that can be used in a mobile device for suppressing noise.

### TECHNICAL BACKGROUND

Mobile devices become more and more important for modern people. Whether in train, MRT, station or town, people always communicate with others by using the mobile devices. Thereby, the audio qualities of the mobile communication products are very important at this time. Especially in the modern society, the noise affects people's life in every place and interferes people's voice communication. In the communication process, the background noise and voice are always mixed together and simultaneously enter into the microphones of the mobile device, and the environment background noise affects the received voice quality so seriously that the remote receiver can not clearly hear the speaker's voice. Nowadays, since the mobile devices is used everyplace and the environment background noise always affects the received quality of the mobile device, that the suppressing noise function is added into the mobile phone will be the trend.

FIG. 1A illustrates a microphone device and audio player according to U.S. Pat. No. 7,577,262. The patent discloses small microphone array with noise reduction and directional function. The small microphone array uses two directional microphones: one is a main microphone and another is a reference microphone. Firstly, the signal from the main microphone is inputted into an adaptive filter, and then the signal from the adaptive filter subtracts the signal from the reference microphone to obtain an accurately reference signal. Finally, it uses the post noise suppression filter to filter noise in the signal from the main microphone.

FIG. 1B illustrates the noise suppression by two-channel tandem spectrum modification for speech signal in an automobile according to U.S. Pat. No. 7,617,099. The patent discloses a suppressing noise technology that uses dual microphones: one is the main microphone and another is the reference microphone. Firstly, it uses the fast Fourier transform (FFT) to translate the signals from the dual microphones to the frequency domain, and then suppresses the noise in the signals. Finally, it uses the inverse fast Fourier transform (IFFT) to translate the signals to the time domain.

FIG. 1C illustrates broadside small array microphone beamforming apparatus according to U.S. Pat. No. 7,706,549. The broadside small array microphone beamforming apparatus uses two omni-directional microphones to be input devices, and it uses the directional microphone forming unit to generate the directional effect as like as the directional microphone. Subsequently, the signal generated from the directional microphone forming unit with the signal from the first microphone enters to the post noise suppression unit at the same time.

### TECHNICAL SUMMARY

The present disclosure provides a method and system for suppressing noise, which has at least two omni-directional microphones respectively mounted on upper end and lower end of two sides of the mobile device, for example, the front side, the back side or the two lateral sides. The present disclose further combines the optimization algorithm of the Wiener filter in time-domain, the minimum mean square error (MMSE) filter and multi-band pass filter to achieve the noise reduction and improve the voice quality.

In one embodiment, the present disclosure provides a suppressing noise system applied in a mobile device, comprising: at least two microphones, for respectively transmitting a first audio signal with noise and a second audio signal with noise; a pre-processing device, coupled to the at least two microphones, for oversampling the first audio signal and the second audio signal, and downsampling the sampled first audio signal and the sampled second audio signal so as to generate a first adjusting signal and a second adjusting signal; and a suppressing noise device, coupled to the pre-processing device, for filtering the first adjusting signal and the second adjusting signal once again and then outputting a third audio signal.

In one embodiment, the present disclosure provides a suppressing noise method applied in a mobile device, comprising: transmitting a first audio signal with noise and a second audio signal with noise; oversampling the first audio signal and the second audio signal, and downsampling the sampled first audio signal and the sampled second audio signal so as to generate a first adjusting signal and a second adjusting signal; and filtering the first adjusting signal and the second adjusting signal once again and then outputting a third audio signal.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A/B/C is a schematic diagram showing a conventional suppressing noise system;

FIG. 2 is a schematic diagram showing a suppressing noise system 2 applied in a mobile device according to one embodiment of the present invention;

FIG. 3 illustrates a detail block diagram showing a suppressing noise system 2 according to one embodiment of the present invention;

FIG. 4 illustrates a suppressing noise method according to one embodiment of the present invention; and

FIG. 5 illustrates an application case according to the suppressing noise system and method of the present invention.

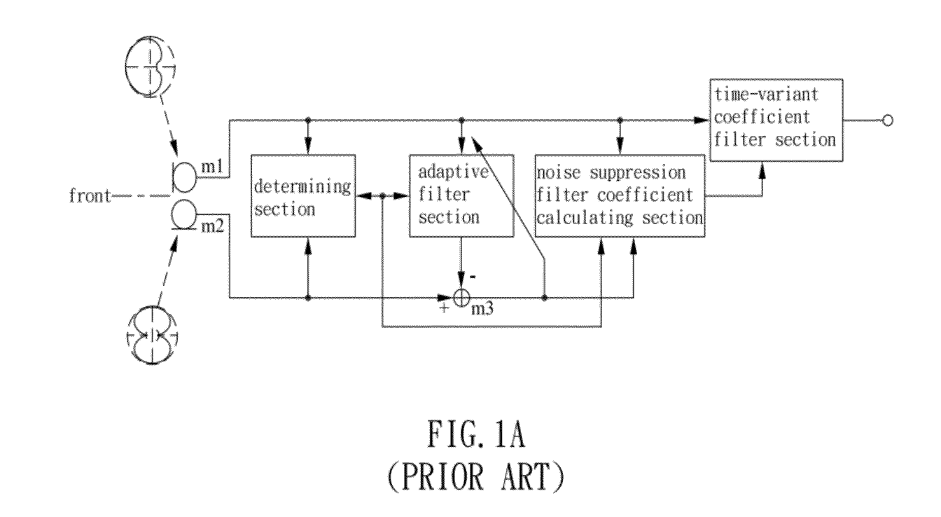

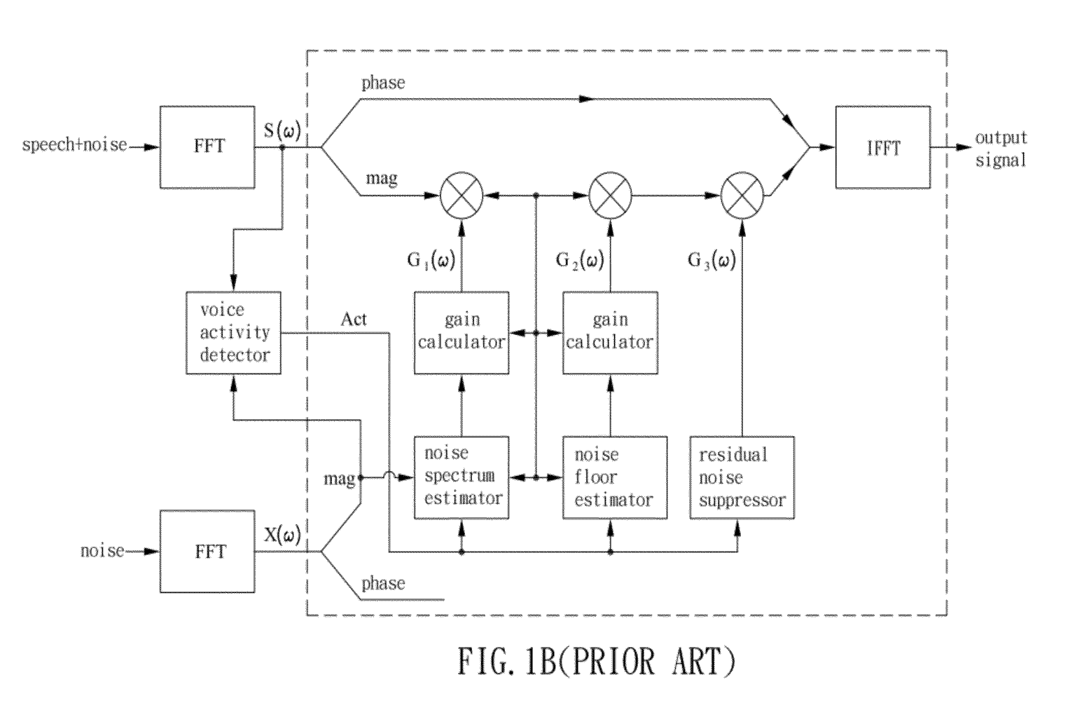

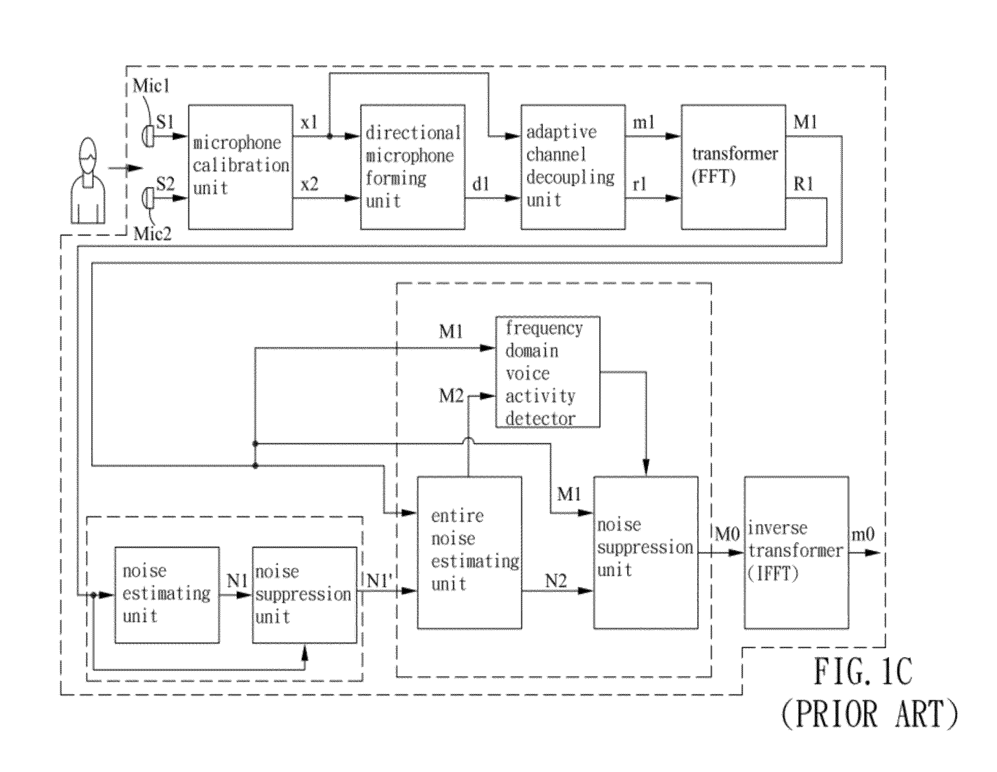

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

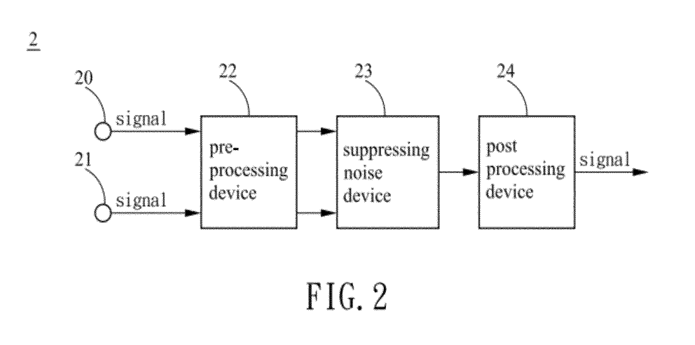

FIG. 2 is a schematic diagram showing a suppressing noise system 2 applied in a mobile device according to one embodiment of the present invention. The system 2 comprises: at least two microphones 20, 21, a pre-processing device 22, a suppressing device 23 and a post processing device 24. The at least two microphones 20, 21 receive a voice message including environment noise, and respectively transmit a first audio signal with noise and a second audio signal with noise to the pre-processing device 22, wherein the first audio signal is a main audio signal. In addition, the at least two microphones 20, 21 are all omni-directional microphones and respectively mounted on upper end and lower end of two sides of the mobile device, for example, the front side, the back side or the two lateral sides. The at least two microphones 20, 21 are the sensors, and the sensor may be a microelectric mechanical systems (MEMS) element or electret condenser microphone (ECM) element.

The pre-processing device 22, which is coupled to the at least two microphones 20, 21, is used for oversampling the first audio signal and the second audio signal, and then downsampling the sampled first audio signal and the sampled second audio signal so as to generate a first adjusting signal and the second adjusting signal. Further, the pre-processing device 22 is used for oversampling the first and second audio signal, for example, 44.1 kHz of the sampling rate, which is higher than 8 kHz. However, it is not limited herein. Subsequently, the sampling rate of the sampled first audio signal and the sampled second audio signal are downsampled to 8 kHz. The suppressing noise device 23 coupled to the pre-processing device 22 is used for filtering the first adjusting signal and the second adjusting signal once again and then outputting a third audio signal. The post processing device 24 coupled to the suppressing noise device is used for modifying the third audio signal.

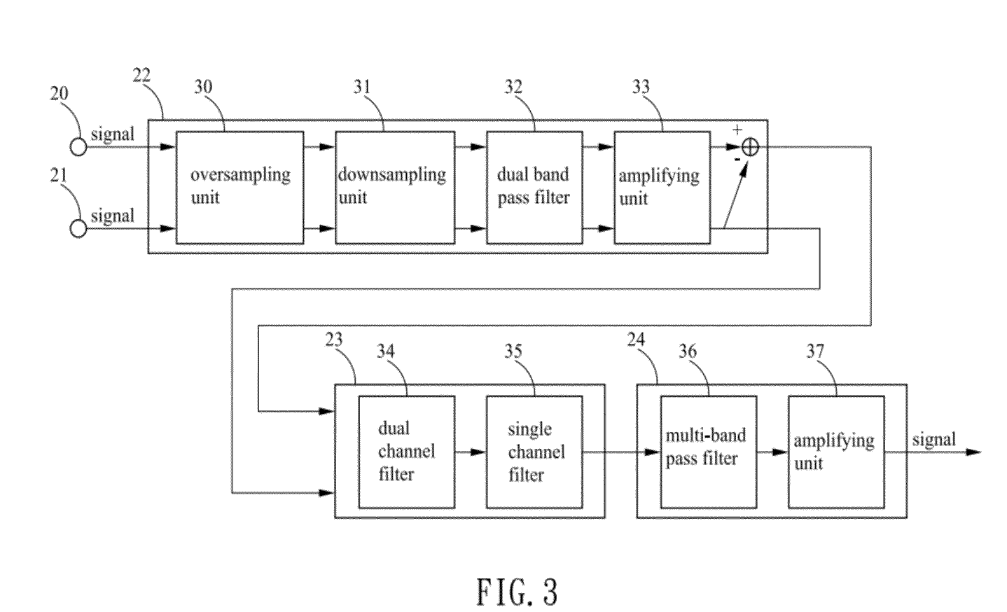

FIG. 3 illustrates a detail block diagram showing a suppressing noise system 2 according to one embodiment of the present invention. In the embodiment, the pre-processing device 22 further comprises: a oversampling unit 30 is used for receiving the first and second audio signals and oversampling the first and second audio signals; a downsampling unit 31 coupled to the oversampling unit 30 is used for downsampling the sampled first audio signal and the sampled second audio signal; a dual band pass filter 32 coupled to the downsampling unit 31 is used for purifying the noise in the first audio signal and the second audio signal and respectively outputting the first and second adjusting signals. Specifically, the sampling rate of the oversampling process is higher than 8 kHz, and the sampling rate of the downsampling process is 8 kHz. However, it is not limited herein. Specifically, the pre-processing device 22 further comprises an amplifying unit 33 coupled to the dual band pass filter is used for amplifying the first and second adjusting audio signals.

In the embodiment, the suppressing noise device 23 further comprises: a dual channel filter 34 is used for receiving the first and second adjusting audio signal, filtering the noise in the first and second adjusting audio signal, and then outputting a third adjusting audio signal; and a single channel filtering unit 35 coupled to the dual band pass filter 34 is used for filtering the noise of the third adjusting audio signal and then outputting the third audio signal. Specifically, the dual channel filter 34 is the Wiener filter in time domain and the single channel filter 35 is the minimum mean square error (MMSE) filter.

In the embodiment, the post processing device 24 further comprises: a multi-band pass filter 36 is used for receiving and modifying the third audio signal; and an amplifying unit 37 coupled to the multi-band pass filter is used for amplifying the third audio signal.

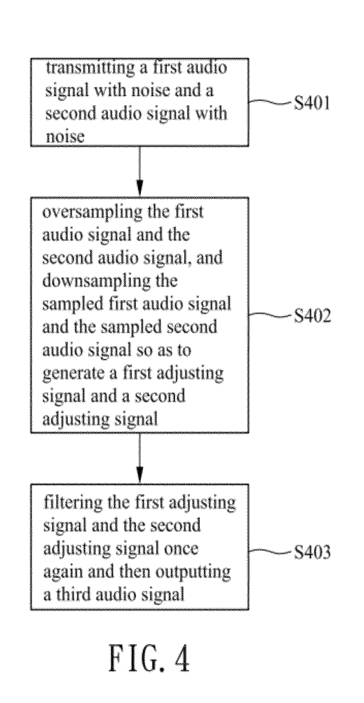

FIG. 4 illustrates a suppressing noise method according to one embodiment of the present invention. The steps of the method comprises: transmitting a first audio signal with noise and a second audio signal with noise (step s401); oversampling the first audio signal and the second audio signal, and downsampling the sampled first audio signal and the sampled second audio signal so as to generate a first adjusting signal and a second adjusting signal (step s402); and filtering the first adjusting signal and the second adjusting signal once again and then outputting a third audio signal (step s403).

In the embodiment, it needs to refer to the suppressing noise system of the FIG. 3 to describe the steps of the suppressing noise method. Firstly, at least two microphones 20, 21 receive a voice message including environment noise, and respectively transmit a first audio signal with noise and a second audio signal with noise to the pre-processing device 22. Subsequently, the oversampling unit 30 in the pre-processing device 22 is used for receiving the first and second audio signals and oversampling the first and second audio signals which the sampling rate is higher than 8 kHz. The downsampling unit 31 in the pre-processing device 22 is used for downsampling the sampled first audio signal and the sampled second audio signal according to the 8 kHz of the sampling rate. The dual band pass filter 32 in the pre-processing device 22 is used for purifying the noise in the first audio signal and the second audio signal, and respectively outputting the first and second adjusting signals. Specifically, the first and second adjusting signals are amplified after the superposition of the first audio signal and the second audio signal.

Subsequently, the dual channel filter 34 in the suppressing noise device 23 is used for receiving the first and second adjusting audio signals and filtering the noise in the first and second adjusting audio signals so as to output a third adjusting signal. The signal channel filtering unit 35 in the suppressing noise device 23 is used for filtering the noise in the third adjust signal and then outputting the third audio signal. Finally, the multi-band pass filter 36 in the post processing device 24 is used for receiving and modifying the third audio signal, and it performs the equalization or modification process for the third audio signal. In addition, the amplifying unit 37 in the post processing device 24 is used for amplifying the third audio signal.

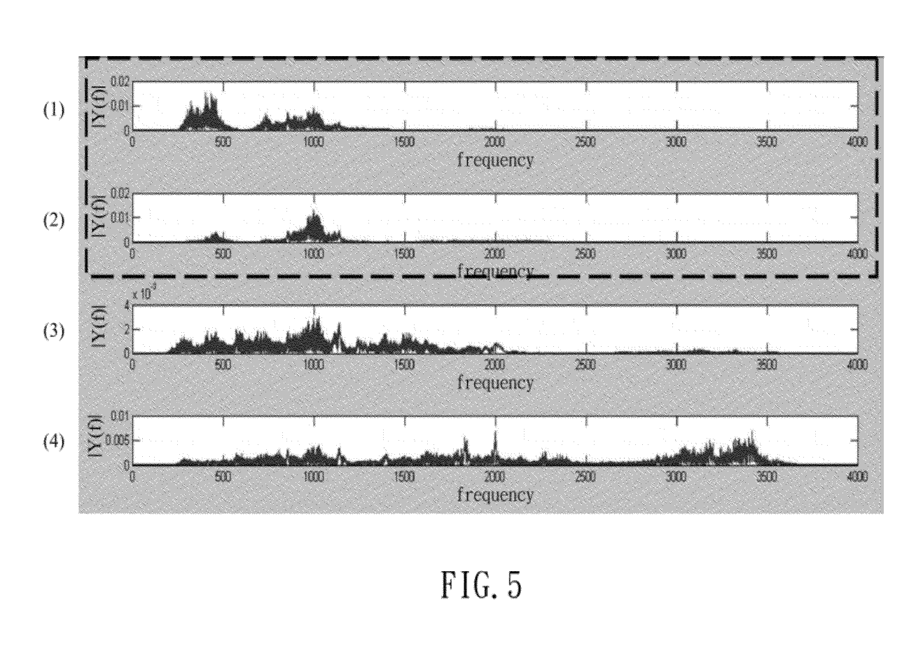

FIG. 5 illustrates an application case according to the suppressing noise system and method of the present invention. As shown in FIG. 5, if the mobile devices use the present invention to perform the noise reduction, the spectral of the signals of these two microphones (FIG. 5 (1) and (2)) show that there are two frequency bands, for example, 300 to 500 Hz and 600 to 1100 Hz. In the contrary, if the mobile devices do not use the present invention to perform the noise reduction, there is no dominated frequency band in the spectral of the audio signals (FIG. 5 (3) and (4)).

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A suppressing noise system applied in a mobile device, comprising:
at least two microphones, for respectively transmitting a first audio signal with noise and a second audio signal with noise;
a pre-processing device, coupled to the at least two microphones, for oversampling the first audio signal and the second audio signal, and downsampling the sampled first audio signal and the sampled second audio signal so as to generate a first adjusting signal and a second adjusting signal; and
a suppressing noise device, coupled to the pre-processing device, for filtering the first adjusting signal and the second adjusting signal once again and then outputting a third audio signal.

2. The system of claim 1, wherein the at least two microphones are omni-directional microphones.

3. The system of claim 1, wherein the at least two microphones are respectively mounted on a front side and a back side, or two lateral sides of a mobile device.

4. The system of claim 1, wherein the at least two microphones are respectively mounted an upper end and a lower end, or the upper end, the lower end and middle end.

5. The system of claim 1, wherein the at least two microphones are the sensors, and the sensor is the microelectric mechanical systems (MEMS) element or electret condenser microphone (ECM) element.

6. The system of claim 1, wherein the pre-processing device further comprises:
a oversampling unit, for receiving the first and second audio signals, and oversampling the first and second audio signals according to the sampling rate of the oversampling unit;
a downsampling unit, coupled to the oversampling unit, for downsampling the sampled first audio signal and the sampled second audio signal according to the sampling rate of the downsampling unit;
a dual band pass filter, coupled to the downsampling unit, for purifying the noise in the first audio signal and the second audio signal, and respectively outputting the first and second adjusting signals.

7. The system of claim 6, further comprising:
an amplifying unit, coupled to the dual band pass filter, for amplifying the first and second adjusting audio signals.

8. The system of claim 6, wherein the sampling rate of the oversampling unit is higher than 8 kHz.

9. The system of claim 6, wherein the sampling rate of the downsampling unit is 8 kHz.

10. The system of claim 1, wherein the suppressing noise device further comprises:
a dual channel filter, for receiving the first and second adjusting signals, and filtering the noise in the first adjusting signal and the second adjusting signal so as to output a third adjusting signal; and
a single channel filtering unit, coupled to the dual channel filter, for filtering the noise in the third adjusting signal and outputting the third audio signal.

11. The system of claim 10, wherein the dual channel filter is the Wiener filter.

12. The system of claim 10, wherein the single channel filtering unit is the MMSE filter.

13. The system of claim 1, further comprising:
a post processing device, coupled to the suppressing noise device, for modifying the third audio signal.

14. The system of claim 13, wherein the post processing device comprises:
a multi-band pass filter, for receiving and modifying the third audio signal; and
an amplifying unit, coupled to the multi-band pass filter, for amplifying the third audio signal.

15. A suppressing noise method applied in a mobile device, comprising:
transmitting a first audio signal with noise and a second audio signal with noise;
oversampling the first audio signal and the second audio signal, and downsampling the sampled first audio signal and the sampled second audio signal so as to generate a first adjusting signal and a second adjusting signal; and
filtering the first adjusting signal and the second adjusting signal once again and then outputting a third audio signal.

16. The method of claim 15, further comprising:
oversampling the first and the second audio signals according to the sampling rate of the oversampling unit.

17. The method of claim 16, wherein the sampling rate of the oversampling unit is higher than 8 kHz.

18. The method of claim 15, further comprising:
downsampling the sampled first audio signal and the sampled second audio signal according to the sampling rate of the downsampling unit;

19. The method of claim 18, wherein the sampling rate of the downsampling unit is 8 kHz.

20. The method of claim 15, further comprising:
purifying the noise in the first audio signal and the second audio signal, and respectively outputting the first and second adjusting signals.

21. The method of claim 20, further comprising:
amplifying the first and second adjusting signals.

22. The method of claim 18, further comprises:
filtering the noise in the first and second adjusting signals so as to output a third adjusting signal by a dual channel filter.

23. The method of claim 22, further comprising:
the dual channel filter is the Wiener filter.

24. The method of claim 15, further comprising:
filtering the noise in the third adjusting signal so as to output the third audio signal by a single channel filtering unit.

25. The method of claim 24, wherein the single channel filtering unit is the MMSE filter.

26. The method of claim 15, further comprising:
receiving and modifying the third audio signal by a multi-band pass filter.

27. The method of claim 22, further comprising:
amplifying the third audio signal.
